(19) United States
(12) Patent Application Publication
(10) Pub. No.: US 2008/0100583 A1
(43) Pub. Date: May 1, 2008

(54) Data Input Arrangement with a Perch

(76) Inventors: Chad Chaumont, East Setauket, NY (US); Shane MaCgregor, Forest Hills, NY (US)

Correspondence Address: FAY KAPLUN & MARCIN, LLP, 150 BROADWAY, SUITE 702, NEW YORK, NY, 10038, US

(21) Appl. No.: 11/610,080

(22) Filed: Dec. 13, 2006

Related U.S. Application Data
(60) Provisional application No. 60/863,278, filed on Oct. 27, 2006.

(51) Int. Cl. G06F 3/02

(52) U.S. Cl. 345/169

(57) ABSTRACT

A data input arrangement includes an array of input keys arranged on a surface; and a perch at least partially extending between first and second rows of the array substantially parallel to one of the first and second rows. The perch extends away from the surface above each of the input keys. The perch is non-responsive to contact and electrically decoupled from a device receiving input from the data input arrangement.

### PRIORITY CLAIM

This application claims the priority to the U.S. Provisional Application Ser. No. 60/863,278, entitle “Data Input Arrangement With a Key Pad Perch,” filed Oct. 27, 2006. The specification of the above-identified application is incorporated herewith by reference.

### FIELD OF THE INVENTION

The present invention relates generally to a data input arrangement with a perch that is within or near an interface of the arrangement and that is part of a housing of the arrangement.

### BACKGROUND

Computing devices include a data input arrangement that allows a user to enter data. The data input arrangement may be a separate unit from the processing unit. For example, a keyboard connects to a computer tower. The data input arrangement may also be part of a single unit. For example, hand held devices include a key pad on the housing. Conventional data input arrangements include keys with a corresponding data input.

Conventional data input arrangements with, for example, key pads are designed to allow a user to easily depress the keys so that a user is not required to forcibly push the keys to input data. However, this design includes disadvantages such as a user inadvertently pressing keys while simply resting the finger on the key pad. Most conventional key pads also include keys that are small and thus have a small surface area for a finger to rest. Convex keys or flat keys have even smaller surface areas than concave keys. Furthermore, a user's finger is likely to be too large to rest on a single key. That is, the user's finger is likely to rest on several keys at a single time, thereby increasing the likelihood of inadvertently pressing keys.

### SUMMARY OF THE INVENTION

A data input arrangement includes an array of input keys arranged on a surface; and a perch at least partially extending between first and second rows of the array substantially parallel to one of the first and second rows. The perch extends away from the surface above each of the input keys. The perch is non-responsive to contact and electrically decoupled from a device receiving input from the data input arrangement.

### DESCRIPTION OF THE DRAWINGS

FIG. 1 shows a data input arrangement for a computing device according to an exemplary embodiment of the present invention.

FIG. 2 shows a perspective view for a second exemplary embodiment including a perch of the data input arrangement of FIG. 1.

FIG. 3 shows a perspective view for a third exemplary embodiment including a perch of the data input arrangement of FIG. 1.

FIG. 4 shows a perspective view for a fourth exemplary embodiment including a perch of the data input arrangement of FIG. 1.

FIG. 5 shows a perspective view for a fifth exemplary embodiment including a perch of the data input arrangement of FIG. 1.

FIG. 6 shows a perspective view for a sixth exemplary embodiment including a perch of the data input arrangement of FIG. 1.

FIG. 7 shows a perspective view for a seventh exemplary embodiment including a perch of the data input arrangement of FIG. 1.

FIG. 8 shows a perspective view for an eighth exemplary embodiment including a perch of the data input arrangement of FIG. 1.

FIG. 9 shows a perspective view for a ninth exemplary embodiment including a perch of the data input arrangement of FIG. 1.

### DETAILED DESCRIPTION

The present invention may be further understood with reference to the following description and the appended drawings, wherein like elements are referred to with the same reference numerals.

The present invention describes a data input arrangement for a computing device (e.g., personal computer, laptop, pager, mobile device, cell phone, radio frequency identification device, scanner, a data acquisition device, an imager, etc.). According to the exemplary embodiments of the present invention, the data input arrangement may exhibit a perch. The data input arrangement and the perch will be discussed in more detail below.

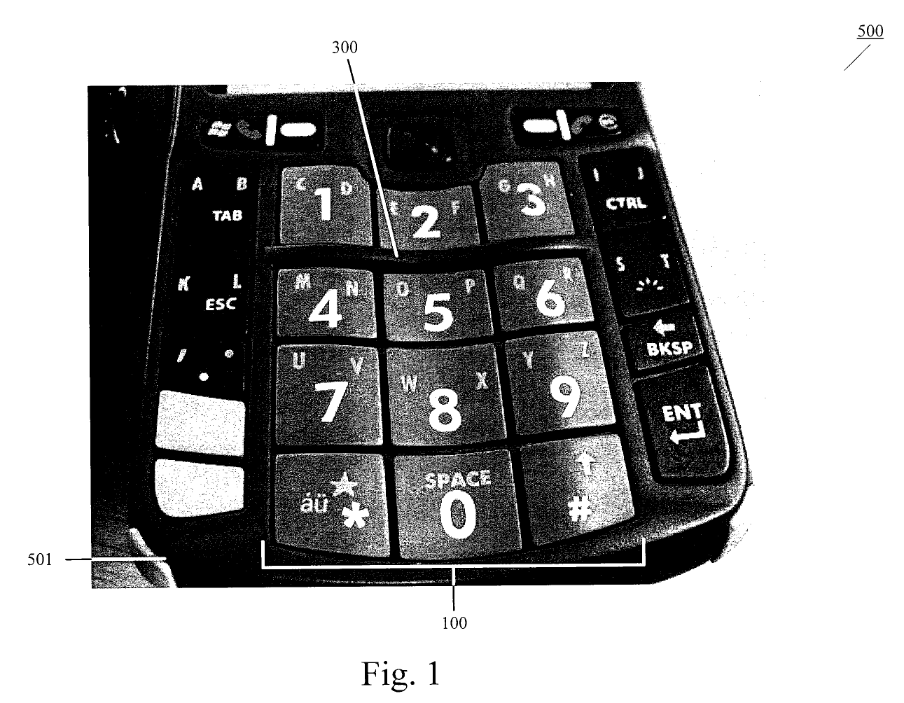

FIG. 1 shows a data input arrangement 500 for a computing device according to an exemplary embodiment of the present invention. Specifically, FIG. 1 illustrates the computing device as a mobile device. It should be noted that the use of a mobile device is only exemplary and, as discussed above, the data input arrangement 500 may be applied to any computing device utilizing a data input arrangement. In the following exemplary embodiments, the data input arrangement 500 is described using a key pad for a mobile device. However, the data input arrangement may be any arrangement that utilizes one or more keys to input data such as a data-centric key pad, numeric key pad, keyboard, etc. It should be noted that the use of keys is only exemplary and the data input arrangement may utilize other data input means such as switches, light sensors, heat sensors, etc.

As shown in FIG. 1, the data input arrangement 500 consists of at least a key pad 100. The key pad 100 is housed in a housing 501. The key pad 100 may include an array of keys (e.g., twelve keys) which may be divided into a plurality of rows and columns (e.g., three columns and four rows). For example, as shown in FIG. 1, from left to right, a first row (top) may include the numbers “1”, “2”, and “3”; a second row may include the numbers “4”, “5”, and “6”; a third row may include the numbers “7”, “8”, and “9”; and a fourth row (bottom) may include “*”, “0”, and “#”.

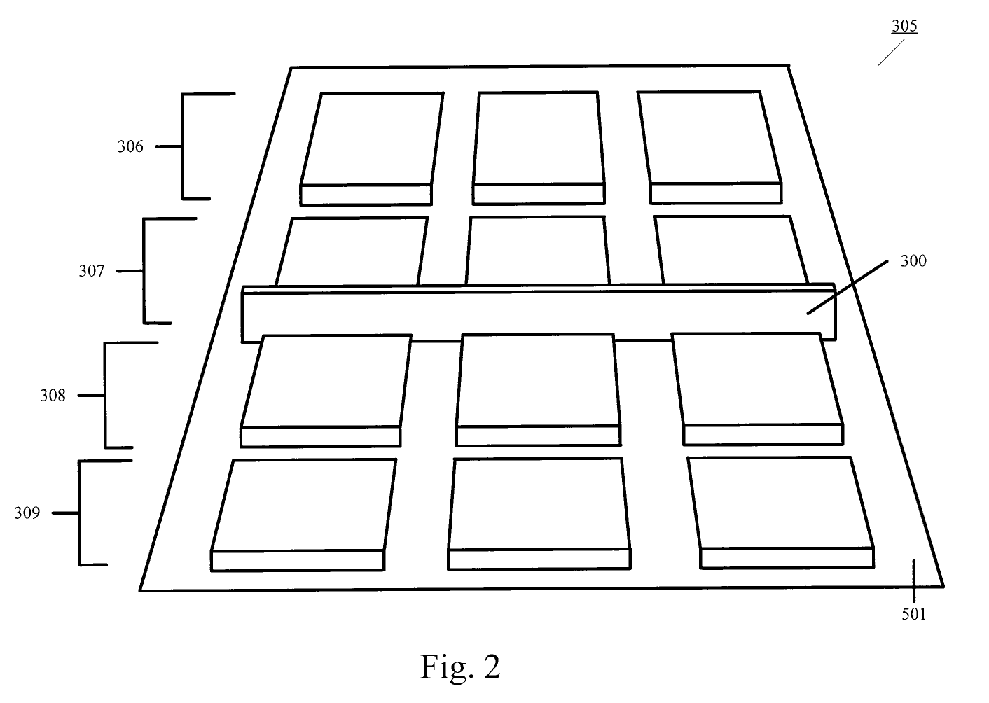

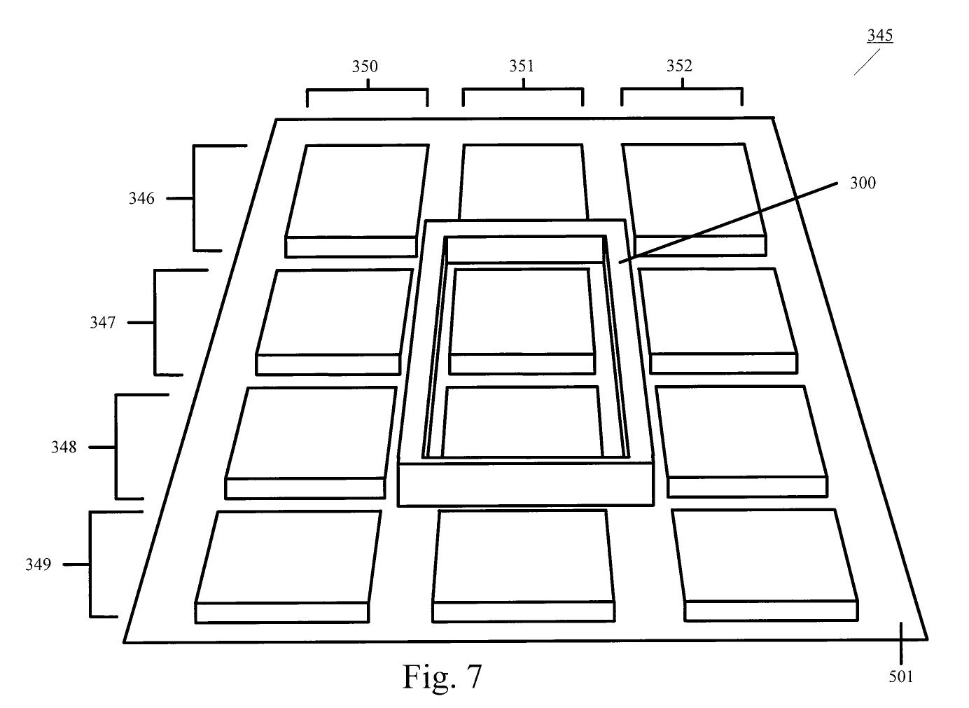

Referring to FIG. 1, the key pad 100 also includes a perch 300. The perch 300 may be an additional piece of a molding within the housing 501 of the mobile unit. The perch 300 may be disposed within the key pad 100 or may be an attachable/removable piece. As illustrated in FIGS. 1 and 7, the molding of the mobile device may be manufactured with the perch 300 (e.g., part of the casting mold), thereby being permanent. Furthermore, the molding may include the perch 300 within the data input arrangement (e.g., FIG. 1) or outside the data input arrangement (e.g., FIG. 7). As illustrated in FIGS. 2-6, the perch 300 may be a separate piece that is combined with the molding of the mobile unit, thereby being attachable/releasable. The perch 300 may be manufactured using similar materials as the molding of the mobile unit. The perch 300 may also be manufactured using different materials (e.g., rubber, plastic, etc.) or coated with an additional material (e.g., cloth, leather, rubber, etc.) that enhance the purposes for which the perch 300 serves. In the exemplary embodiments, the perch 300 is illustrated as being slightly elevated above the keys of the key pad 100. However, it should be noted that the elevation of the perch 300 is only exemplary and the perch 300 may be even with the keys or at a lower height than the keys.

As illustrated in FIG. 1, a first exemplary embodiment shows the perch 300 disposed between the first (top) and second rows of the key pad 100. The perch 300 may exhibit the same shape as the key pad 100. For example, if the key pad 100 has a linear shape, then the perch 300 may exhibit the same linear shape. If the key pad 100 has an angled shape or wave shape, then the perch 300 may exhibit the same angled shape or wave shape. If the key pad 100 has an amorphous shape, then the perch 300 may exhibit the same amorphous shape. However, it should be noted that the perch 300 may also exhibit an independent shape, where the perch 300 may be linear while the key pad 100 may be angled or amorphous and vice versa. It should be noted that the disposition of the perch 300 between the first and second rows is only exemplary. The perch 300 may exist anywhere on the data input arrangement 500, as will be discussed in more detail below.

FIG. 2 shows a second exemplary embodiment 305 of the perch 300 disposed in the key pad 100 with rows 306-309. Specifically, in the exemplary embodiment 305, the perch 300 is disposed between the second (e.g., row 307) and third (e.g., row 308) rows of the key pad 100. As discussed above, the perch 300 in FIG. 2 exhibits a linear shape and is attachable/removable. Those skilled in the art will understand that an attachable/removable perch 300 may be subsequently moved in between other rows (e.g., between the third row 308 and the fourth row 309). It should be noted that the perch 300 may be between other rows as part of the molding of the mobile device as well.

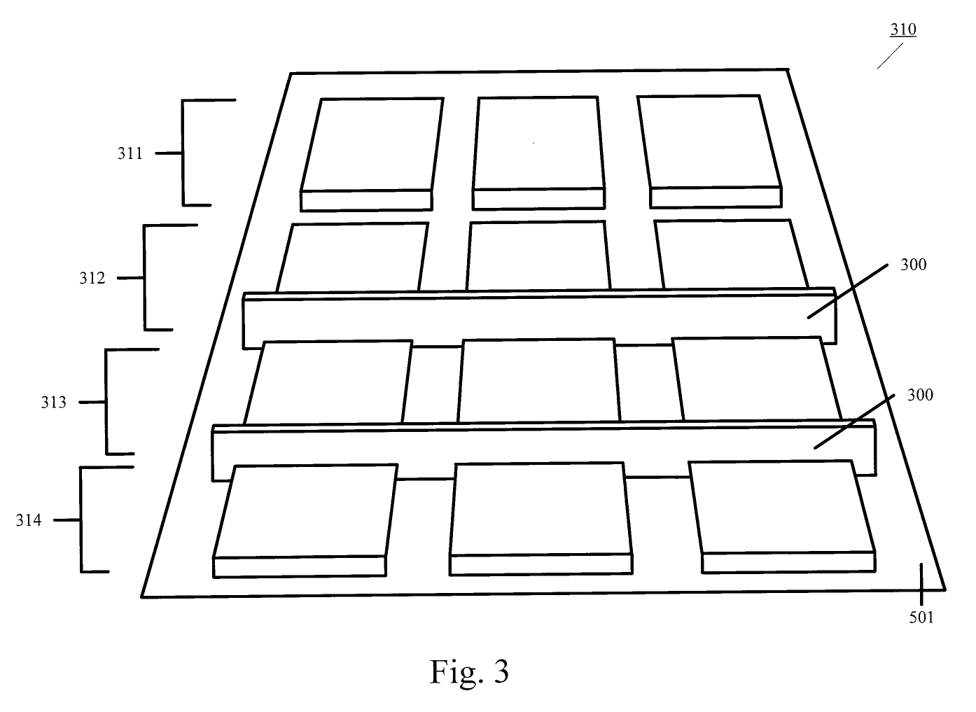

FIG. 3 shows a third exemplary embodiment 310 of the perch 300 disposed in the key pad 100 with rows 311-314. Specifically, in the exemplary embodiment 305, one perch 300 is disposed between the second (e.g., row 312) and third (e.g., row 313) rows and one perch 300 is disposed between the third (e.g., row 313) and fourth (e.g., row 314) rows of the key pad 100. That is, the third exemplary embodiment 310 illustrates that the perch 300 may exist as multiple perches disposed within the key pad 100.

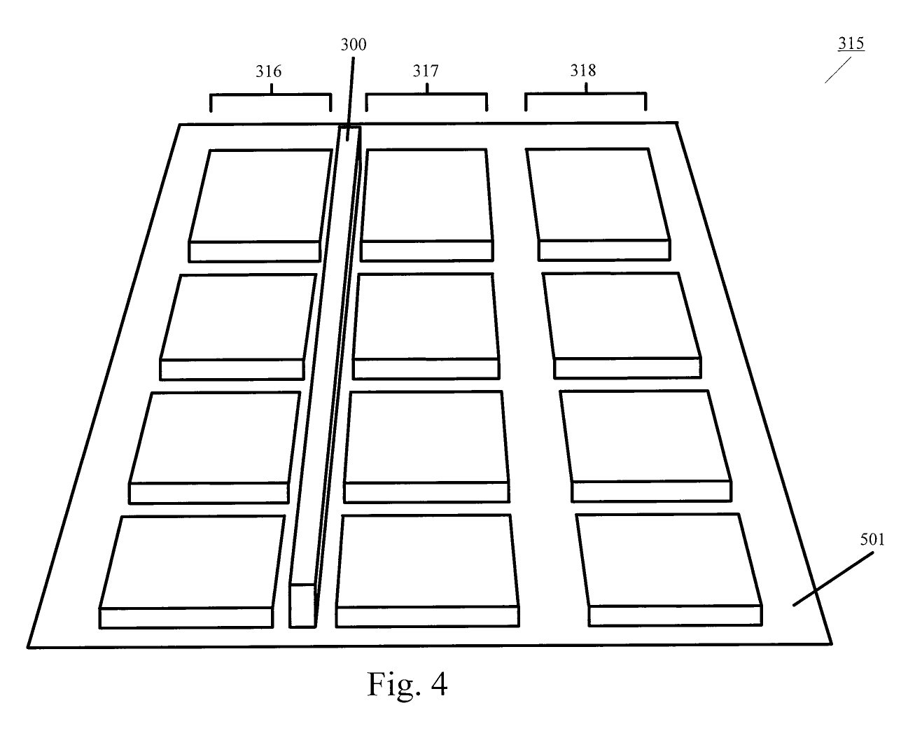

FIG. 4 shows a fourth exemplary embodiment 315 of the perch 300 disposed in the key pad 100 with columns 316-318. Specifically, in the exemplary embodiment 315, the perch 300 is disposed between the first (e.g., column 316) and second (e.g., column 317) columns of the key pad 100. That is, the fourth exemplary embodiment 315 illustrates that the perch 300 may exist longitudinally as opposed to a lateral disposition as shown in FIGS. 1-3. Furthermore, multiple perches may exist longitudinally, analogous to the lateral perches of FIG. 3.

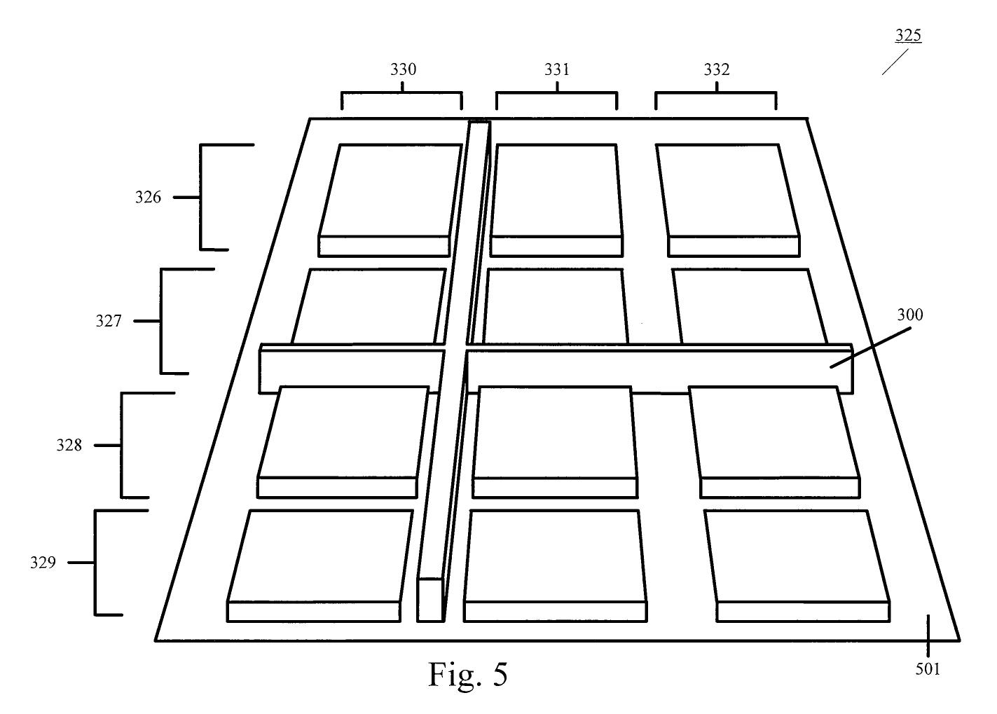

FIG. 5 shows a fifth exemplary embodiment 325 of the perch 300 disposed on the key pad 100 with rows 326-329 and columns 330-332. Specifically, in the exemplary embodiment 325, the perch 300 exists as a cross-shape disposed between the second (e.g., row 327) and third (e.g., row 328) rows and between the first (e.g., column 330) and second (e.g., column 331) columns of the key pad 100. The disposition of the perch 300 between the second and third rows and between the first and second columns is only exemplary. The cross-shaped perch 300 may be located between any of the rows and any of the columns. In addition, those skilled in the art will understand that this form of perch 300 may also be exhibited as an H-shape, a Y-shape, etc. That is, for example, the perch 300 may include one leg between the first and second column, one leg between the second and third column, and one leg between the second and third row.

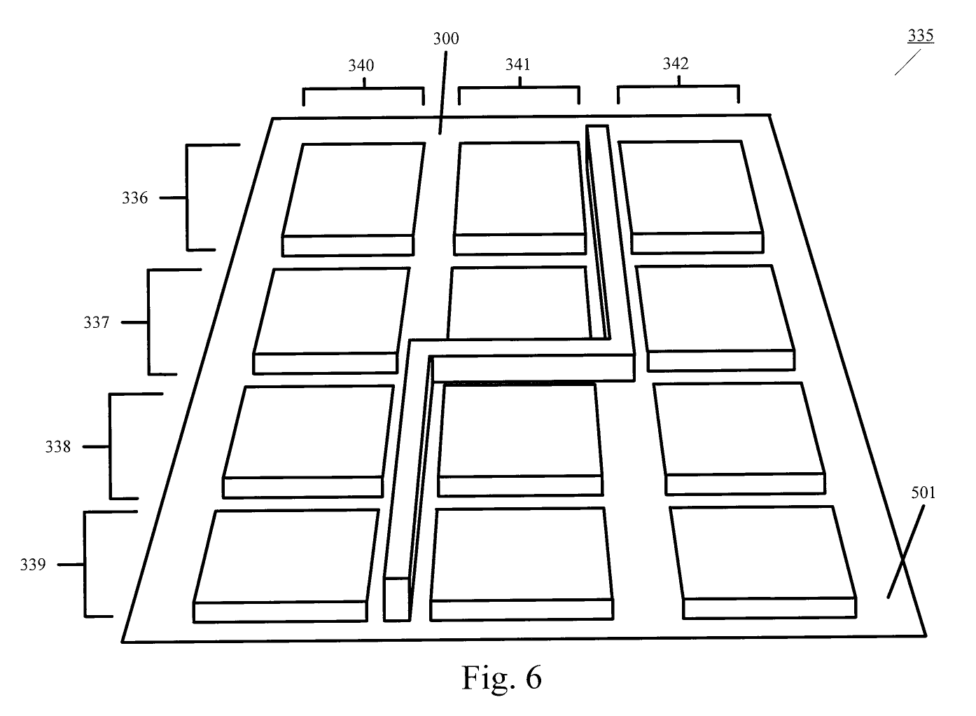

FIG. 6 shows a sixth exemplary embodiment 335 of the perch 300 disposed on the key pad 100 with rows 336-339 and columns 340-342. Specifically, in the exemplary embodiment 335, the perch 300 exists as a substantial stair shape. A portion of the perch 300 is disposed between column 340 and column 341 with a length from a point below row 339 to a point between row 337 and row 338. Another portion of the perch 300 is disposed between column 341 and column 342 with a length from a point above row 336 to a point between row 337 and row 338. Yet another portion of the perch 300 is disposed between row 337 and row 338 with a length from a point between row 340 and row 341 to a point between row 341 and row 342. That is, the perch 300 may extend an entire longitudinal length while only extending a partial lateral length of the key pad 100. However, these extensions are only exemplary and the perch 300 may extend an entire lateral length while only extending a partial longitudinal length of the key pad 100. It should be noted that the substantial stair shape is only exemplary and other shapes that exhibit similar properties may be used. Furthermore, the stair shape may include further “steps” within the key pad 100.

FIG. 7 shows a seventh exemplary embodiment 345 of the perch 300 disposed on the key pad 100 with rows 346-349 and columns 350-352. Specifically, in the exemplary embodiment 345, the perch 300 exists as a hollow rectangle-shape with two substantially parallel legs disposed between the first (e.g., row 346) and second (e.g., row 347) rows and between the third (e.g., row 348) and fourth (e.g., row 349) rows and the other two substantially parallel legs disposed between the first (e.g., column 350) and second (e.g., column 351) columns and between the second (e.g., column 351) and third (e.g., column 352) columns of the key pad 100. That is, the perch 300 extending the length or width of the key pad 100 is only exemplary and the perch 300 may be disposed completely within the key pad 100. The disposition of the perch 300 as the hollow rectangle shape is only exemplary. The form of the perch 300 in the seventh exemplary embodiment 345 shows that the perch 300 may exhibit any shape disposed between any row and any column. It should be noted that the placement of the perch 300 between the rows and columns is also exemplary and the perch 300 may be placed accordingly depending on the shape of the keys. That is, if the keys of the key pad 100 are, for example, triangular, the perch 300 may be disposed diagonally or angled.

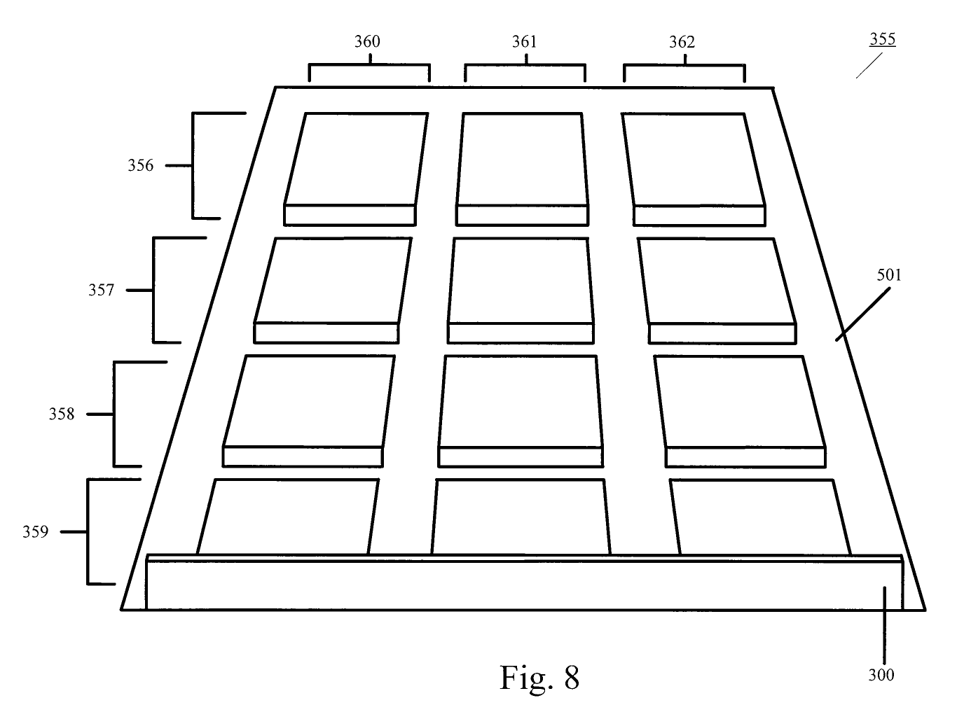

FIG. 8 shows an eighth exemplary embodiment 355 of the perch 300 disposed in the key pad 100 with rows 356-359. Specifically, in the exemplary embodiment 355, the perch 300 is disposed on the bottom edge of the key pad 100 (i.e., below the fourth row 359). As discussed above, the eighth exemplary embodiment 355 illustrates that the perch 300 may exist as part of the housing of the mobile device at an edge of the key pad 100 (e.g., in contrast to being a part of the housing and disposed within the key pad 100). As illustrated, it should be noted that the perch 300 may exist outside the boundaries of the key pad 100, such as on the housing 501. That is, the perch 300 may also exist above the first row 356, to the left of column 360, or to the right of column 362. Furthermore, the perch 300 may exist as multiple perches, as described above with reference to FIG. 3. For example, the perch 300 may exist on the bottom edge (i.e., below the fourth row 359) and also along the left edge (i.e., left of column 360). In another example, the perch 300 may encompass the entire area of the key pad 100. That is, the perch 300 may exist on the bottom edge (i.e., below the fourth row 359), along the left edge (i.e., left of column 360), on the top edge (i.e., above the first row 356), and along the right edge (i.e., right of column 362).

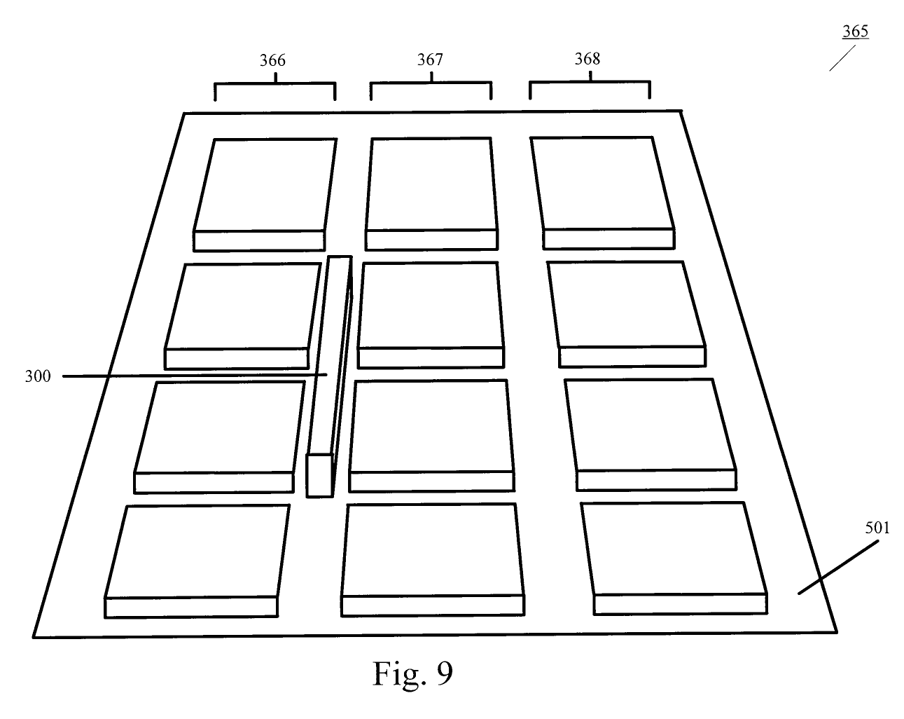

FIG. 9 shows a ninth exemplary embodiment 365 of the perch 300 disposed in the key pad 100 with columns 366-368. Specifically, in the exemplary embodiment 365, the perch 300 is disposed between the column 366 and the column 367. Furthermore, the perch 300 extends partially and substantially parallel to the length of the column. It should be noted that the perch 300 disposed in between columns is only exemplary and the perch 300 may be disposed between the rows as well. The ninth exemplary embodiment 365 also illustrates the perch 300 disposed completely within the key pad 100 (e.g., the hollow rectangle shape of the seventh embodiment 345 of FIG. 7). Furthermore, the embodiment 365 also shows that when the perch 300 is completely within the key pad 100, the linear form may also be used. It should be noted that the linear form is also exemplary and the perch 300 may also be shortened to be as small as a point or extend beyond the shown length.

The perch 300 provides several advantages over conventional key pads. An exemplary advantage of the perch 300 is to provide a surface to rest the user's finger. In one embodiment, the perch 300 may be solid and immovable. In another embodiment, the perch 300 may be solid and slightly pressable to, for example, provide ease of use. However, the perch 300 may only be pressed a distance that does not exceed a top level with which the keys of the key pad 100 exist. Thus, immovable or pressable, the perch 300 provides a surface to which a user's finger may rest with little to no chance of inadvertent pressing. That is, the perch 300 is non-responsive to contact by the user. Since the perch 300 is a part of the housing, the perch 300 contains no electrical coupling with the mobile device allowing a user to freely rest a finger(s) on the perch 300.

Another exemplary advantage of the perch 300 is for identification purposes. The perch 300 may provide a means for a user to blindly identify/locate keys on the key pad 100. For example, with reference to the embodiment illustrated in FIG. 1, if a user is resting a finger on the perch 300, the user will readily identify that moving the finger above the perch 300 will result in keys in the first row (e.g., numbers “1”, “2”, “3”) while moving the finger below the perch 300 will result in keys in the second row (e.g., numbers “4”, “5”, “6”). Furthermore, the user may also readily identify that moving the finger below the perch 300 beyond the second row results in keys of the third row, etc. Even if a user is not resting a finger on the perch 300, when a user blindly feels the key pad 100, contact with the perch 300 will alert the user of the row in which the finger is located. Furthermore, the other embodiments and shapes of the perch 300 described above with reference to FIGS. 2-7 allow for a more convenient means of identifying/locating of the keys on the data input arrangement 500.

It should be noted that the above described advantages are only exemplary and that other advantages exist for the perch 300. For example, the perch 300 may provide stability to flexible data input arrangements. However, the perch 300 may be bendable to a degree to allow the data input arrangement to flex as the user desires. In another example, the perch 300 may provide a safety mechanism. In a scenario where a computing device is dropped that may damage the data input arrangement, the perch 300 may be disposed in a position to prevent damage to a more costly key pad (e.g., holographic keys). The application of the perch 300 is only exemplary and the perch 300 may be exhibited on other objects that require the advantages of a perch.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A data input arrangement, comprising:
an array of input keys arranged on a surface; and
a perch at least partially extending between first and second rows of the array substantially parallel to one of the first and second rows, the perch extending away from the surface above each of the input keys, the perch being non-responsive to contact and electrically decoupled from a device receiving input from the data input arrangement.

2. The data input arrangement of claim 1, wherein the perch at least partially extends a length of one of a lateral and longitudinal length of the data input arrangement.

3. The data input arrangement of claim 1, wherein a shape of the perch is one of a line, a cross, a rectangle and a substantial stair shape.

4. The data input arrangement of claim 1, further comprising:
at least one further perch at least partially extending between the second row and a third row of the array substantially parallel to one of the second and third rows, the at least one further perch extending away from the surface above each of the input keys, the at least one further perch being non-responsive to contact and electrically decoupled from the device.

5. The data input arrangement of claim 1, wherein the perch extends away from the surface in a contoured configuration exhibited by the array.

6. The data input arrangement of claim 1, wherein the perch is situated in a manner to identify a location of individual keys among the array of input keys.

7. The data input arrangement of claim 1, wherein the perch is one of a permanent perch and a removable perch.

8. The data input arrangement of claim 1, wherein a computing device includes the data input arrangement.

9. The data input arrangement of claim 8, wherein the computing device includes at least one of a personal computer, a laptop computer, a mobile device, a pager, a cell phone, an imaging scanner, a laser scanner, a data acquisition device, a radio frequency identification device/tag, a barcode reader, and a wearable computing device.

10. A system, comprising:
a housing;
a data input arrangement at least partially disposed within at least a portion of the housing, the data input arrangement including a surface and an array of input keys arranged on the surface; and
a perch at least partially extending between first and second rows of the array substantially parallel to one of the first and second rows, the perch extending away from the surface above each of the input keys, the perch being non-responsive to contact and electrically decoupled from at least one of the housing and the data input arrangement.

11. The system of claim 10, wherein the perch at least partially extends a length of one of a lateral and longitudinal length of the data input arrangement.

12. The system of claim 10, wherein a shape of the perch is one of a line, a cross, a rectangle and a substantial stair shape.

13. The system of claim 10, further comprising:
at least one further perch at least partially extending between the second row and a third row of the array substantially parallel to one of the second and third rows, the at least one further perch extending away from the surface above each of the input keys, the at least one further perch being non-responsive to contact and electrically decoupled from at one of the housing and the data input arrangement.

14. The system of claim 10, wherein the perch extends away from the surface in a contoured configuration exhibited by the array.

15. The system of claim 10, wherein the perch is situated in a manner to identify a location of individual keys among the array of input keys.

16. The system of claim 10, wherein the perch is one of a permanent perch and a removable perch.

17. The system of claim 10, wherein the system is one of a personal computer, a laptop computer, a mobile device, a pager, cell phone, an imaging scanner, a laser scanner, a data acquisition device, a radio frequency identification device, a barcode reader and a wearable device.

18. A data input arrangement, comprising:
an array of input keys arranged on a surface, the array having a contoured configuration; and
a perch extending at least partially along and substantially parallel to a row of the array, the perch extending away from the surface above each of the input keys in the contoured configuration, the perch being non-responsive to contact and electrically decoupled from a device receiving input from the data input arrangement.

19. The data input arrangement of claim 18, wherein the contoured configuration is a non-flat surface consisting of one of a wave shape and an angled shape.

20. A data input system, comprising:
an array of first means for receiving input data, the first means being arranged on a surface; and
a second means for separating at least two of the first means, the second means at least partially extending between first and second rows of the array substantially parallel to one of the first and second rows, the second means extending away from the surface above each of the first means, the second means being non-responsive to contact and electrically decoupled from a device receiving the input data.
